(19) United States
(12) Patent Application Publication
(10) Pub. No.: US 2025/0117626 A1
(43) Pub. Date: Apr. 10, 2025

(54) ARTIFICIAL INTELLIGENCE INFERENCING VIA DELTA MODELS

(71) Applicant: Microsoft Technology Licensing, LLC, Redmond, WA (US)

(72) Inventors: Sanjay RAMANUJAN, Sammamish, WA (US); Ciprian CHISALITA, Kirkland, WA (US); Pei-Hsuan HSIEH, Redmond, WA (US); Derek Edward HYATT, Arnold, MD (US); Rakesh KELKAR, Bellevue, WA (US); Karthik RAMAN, Sammamish, WA (US)

(73) Assignee: Microsoft Technology Licensing, LLC, Redmond, WA (US)

(21) Appl. No.: 18/483,447

(22) Filed: Oct. 9, 2023

(51) Int. Cl. G06N 3/0455

(52) U.S. Cl. CPC G06N 3/0455

(57) ABSTRACT

A computing device is provided, including processor and a storage device holding instructions that are executable by the processor to implement a base artificial intelligence (AI) model and two or more delta AI models, each delta AI model having lower dimensionality than the base AI model. An inference request including an input prompt is received, the inference request specifying a selected delta AI model of the two or more delta AI models. The input prompt is input to the base AI model to thereby generate a base model result vector. The input prompt is input to the selected delta AI model to thereby generate a delta model result vector. An output vector is generated by combining the base model result vector and the delta model result vector via a combination operation. The output vector is output.

### BACKGROUND

Artificial intelligence (AI) models are applicable to a wide range of different applications, including natural language processing, computer vision, speech recognition, etc. While AI models often perform well on tasks for which they were specifically trained, it is sometimes desirable to re-train or fine tune the models to improve their performance in more specific domains or contexts. For instance, a general-purpose language generation model may be adapted to improve its performance in a specific field (such as medicine or language translation) and/or adapted to improve its performance for a particular user's or customer's preferences, as examples. Such model adaptation can be a time consuming and resource-intensive process, particularly for large AI models having many model parameters.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A computing device is provided, including a processor and a storage device holding instructions that are executable by the processor to implement a base artificial intelligence (AI) model and two or more delta AI models, each delta AI model having lower dimensionality than the base AI model. An inference request including an input prompt is received, the inference request specifying a selected delta AI model of the two or more delta AI models. The input prompt is input to the base AI model to thereby generate a base model result vector. The input prompt is input to the selected delta AI model to thereby generate a delta model result vector. An output vector is generated by combining the base model result vector and the delta model result vector via a combination operation. The output vector is output.

### BRIEF DESCRIPTION OF THE DRAWINGS

FIG. 1A schematically shows a computing device for use in artificial intelligence (AI) inference, in which an input prompt is input to a base AI model and a selected delta AI model to thereby generate an output vector.

FIG. 1B shows an example in which the computing device of FIG. 1A is used to generate a second output vector by inputting a second input prompt to the base AI model and a second selected delta AI model.

FIG. 2 schematically shows an example distributed AI inferencing platform in which different base AI models and delta AI models are implemented by a plurality of different computing devices.

FIGS. 3A and 3B schematically illustrate loading of model parameters of a selected delta AI model from memory of a central processing unit (CPU) to memory of a graphics processing unit (GPU) of an example computing device.

FIG. 4 illustrates an example operation in which base model and delta model computations are applied to an input vector to generate an output vector.

FIG. 5A is a flowchart of an example method for AI inferencing.

FIG. 5B is a flowchart of a method that occurs at least partially concurrently with the method of FIG. 5A, in one example.

FIG. 6 is a flowchart of another example method for AI inferencing.

FIG. 7 schematically illustrates an example computing system used to implement a plurality of delta AI models.

FIG. 8 schematically shows an example computing system.

### DETAILED DESCRIPTION

As discussed above, challenges exist in adapting previously trained artificial intelligence (AI) models to improve their performance in different contexts. Full re-training of an AI model can become prohibitively expensive as the size of the model increases. For instance, some AI models have on the order of hundreds of billions of individual parameters, any or all of which may be updated during model re-training. As such, so-called “delta AI models” have been used to adapt previously trained AI models (referred to herein as “base” AI models), where a delta AI model has significantly fewer trainable parameters than the base AI model it is used to adapt. As one non-limiting example, delta AI models include Low-Rank Adaption (LoRA) models. Additional non-limiting examples of delta models will be given below.

However, while delta AI models can be used to successfully adapt a base AI model, their use can present challenges during model deployment. For instance, in some embodiments, delta AI models are implemented by injecting trained decomposition matrices into the base AI model, or otherwise merging parameters of the delta AI model with the base AI model. This results in an adapted iteration of the base model that has been tailored toward a different context, although is similar in size to the base model when deployed. Due to the relatively large size of a typical base AI model, this means that any single computing device (e.g., an individual server computer) often can only implement one adapted iteration of any given base AI model at a time. As a result, the computing device cannot fulfill an inference request targeting a different adapted iteration of the base AI model without first replacing the adapted iteration currently loaded into memory, which reduces inferencing throughput.

Accordingly, the present disclosure is directed to techniques for AI model inferencing in which a base AI model and two or more different delta AI models are implemented by the same computing device. During inferencing, an input vector is provided separately to the base AI model and a selected delta AI model. The resulting vectors output by the base AI model and selected delta AI model are combined to generate an output vector, which is then output as a response to the input vector. However, this does not preclude the computing device from concurrently generating a different output vector using the base model and a different delta AI model as a response to a different input vector—e.g., corresponding to a different user or customer. In this manner, the same computing device can concurrently fulfill inference requests specifying different delta AI models that adapt the base AI model in different ways.

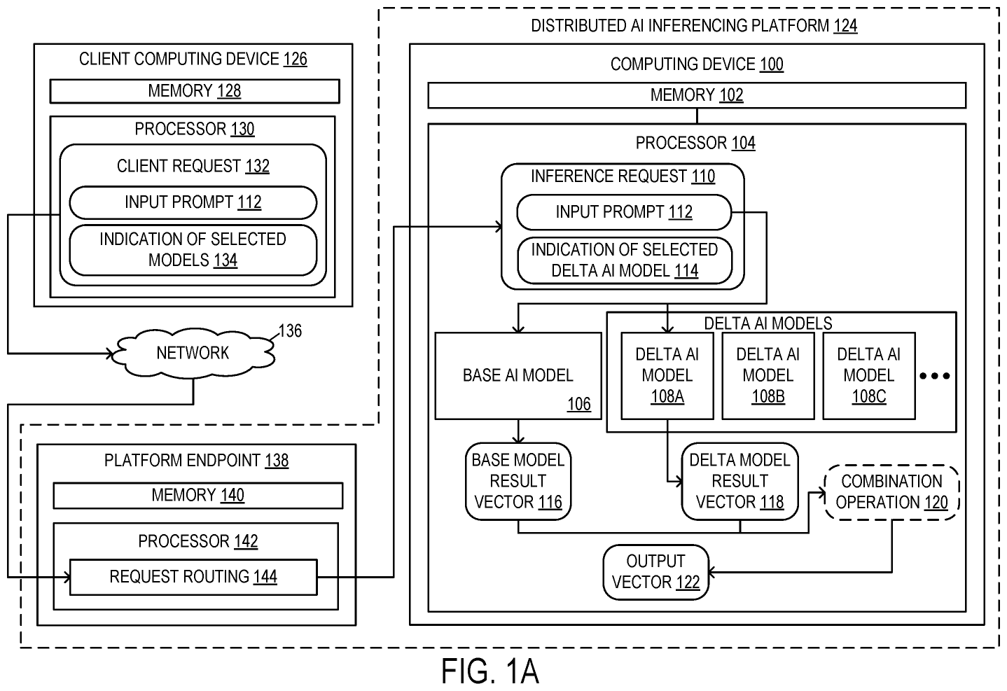

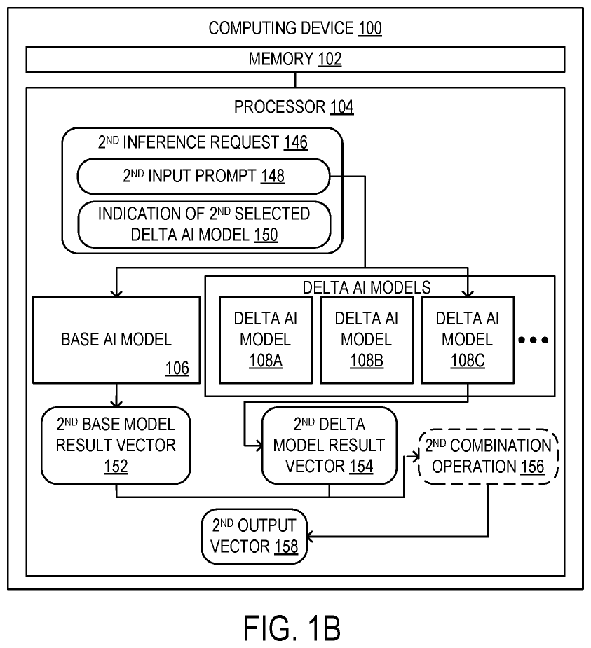

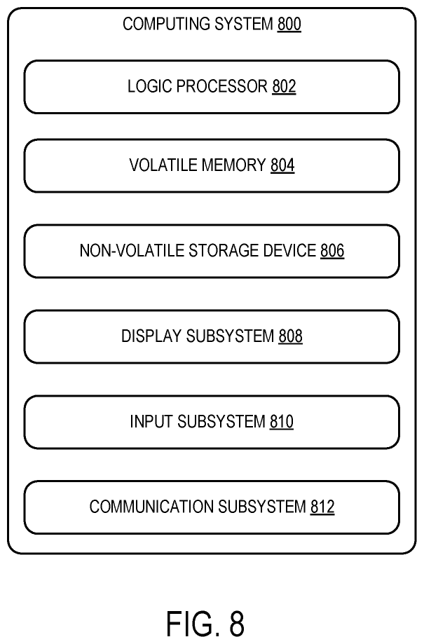

FIG. 1A schematically shows an example computing device 100 used to implement any or all of the AI inferencing techniques described herein. Computing device 100 includes a memory 102 and processor 104. As one example, computing device 100 takes the form of a server computer. As will be described in more detail below, in some examples, the computing device is a component of a distributed AI inferencing platform that is implemented by a plurality of different computing devices, although this is non-limiting. In other examples, the computing device takes another suitable form, such as a personal computer. In general, computing device 100, as well as the other computing devices described herein, has any suitable capabilities, hardware configuration, and form factor. Any or all of the computing devices described herein may in some cases be implemented as computing system 800 described below with respect to FIG. 8.

According to the techniques described herein, a computing device implements a base artificial intelligence (AI) model and two or more delta AI models. In the example of FIG. 1A, computing device 100 implements a base AI model 106 and a set of delta AI models, three of which are labeled as delta AI models 108A-108C. It will be understood that any suitable number of base models, and any suitable number of delta AI models may be implemented by the same computing device, depending on the capabilities of the computing device (e.g., memory capacity), the size of the base AI model, and the relative size of each delta AI model. Increasing the number of delta AI models implemented by a single computing device can increase the potential inferencing throughput of the computing device. In some examples, the quantity of delta AI models implemented by a single computing device is dynamically selected based on a service level agreement (SLA) with one or more users, customers, or other parties, and/or selected based on a cost of goods sold (COGS) calculation.

Although the present disclosure primarily focuses on embodiments where only one base AI model is implemented by a single computing device, it will be understood that this is non-limiting. Rather, in some embodiments, two or more base AI models may be implemented concurrently by the same computing device.

As used herein, a base AI model or delta AI model is “implemented” by a computing device when parameters of the AI model are loaded into memory of the computing device, such that the AI model can be executed by the processor of the computing device. This may include loading model parameters into random access memory (RAM) of the computing device, memory of a graphics processing unit (GPU), memory of a central processing unit (CPU), and/or other suitable volatile or non-volatile memory. It will be understood that an AI model may be “implemented” without requiring that every parameter for the AI model be loaded into memory-rather, in some cases, only parameters relevant to a current ongoing operation are loaded, while other parameters of the AI model are stored in non-volatile storage. Notably, two or more AI models implemented by the computing device at the same time can be used concurrently to generate different output vectors. In some examples, one or more of the AI models implemented by the computing device are instantiated via different virtual machines or containers hosted on the computing device. For instance, in one embodiment, each different delta AI model is instantiated in a different virtual machine or container hosted by the computing device.

A “base AI model” refers to any suitable AI or artificial intelligence (AI) model, algorithm, or other suitable data structure parameterized by a plurality of trained parameters, and usable to generate an output vector in response to an input prompt. In some embodiments, the base AI model is a transformer model, although it will be understood that this is non-limiting. Other non-limiting examples of AI and/or machine learning (ML) technologies that may be used to implement a base AI model include support vector machines, multi-layer neural networks, convolutional neural networks, and/or recurrent neural networks.

Similarly, a “delta AI model” refers to any suitable AI or AI model, algorithm, or suitable data structure that, when combined with or used in tandem with a base AI model, adapts the performance of the base AI model without requiring a full re-training process in which every parameter of the base AI model is changed. In some embodiments, the two or more delta AI models are selected from a group consisting of Low-Rank Adaptation (LoRA) models, BitFit models, Adapter models, and Compactor models. In general, a delta AI model has lower dimensionality than the base AI model, which contributes to the reduced storage space required to store parameters of the delta AI model in memory. It has been shown that, when adapting an AI model, the weight matrices of the AI model have an intrinsic rank that is relatively low compared to the number of dimensions represented in the weight matrices. As such, delta AI models can efficiently adapt a base AI model toward a different context despite having a dimensionality that is, in some embodiments, significantly lower than the base AI model. In the specific case of LoRA models, the parameters of the base AI model are frozen, while rank decomposition matrices are trained for each layer of the base AI model. This has been shown to successfully adapt pre-trained AI models toward different contexts, while significantly reducing the number of parameters that are trained during model adaptation.

In FIG. 1A, computing device 100 receives an inference request 110. The inference request includes an input prompt 112 and an indication 114 of a selected delta AI model. In other words, the inference request specifies a selected delta AI model of the two or more delta AI models implemented by the computing device. As will be described in more detail below, the input prompt is input to the base AI model and a delta AI model of the set of delta AI models implemented by the computing device to generate respective result vectors, which are then combined to generate an output vector for the input prompt. As such, the input prompt takes the form of any data suitable for input to the AI models for inference. As non-limiting examples, the input prompt may be an encoded representation of text data (e.g., a natural language input typed, spoken, or otherwise provided by a human user), image data (e.g., for image classification or facial recognition), audio data (e.g., for speech recognition), and/or video data.

In some embodiments, the input prompt is provided to the base AI model and the selected delta AI model as an input vector—e.g., a vector representation of the underlying information encoded by the input prompt. As such, in some embodiments, the computing device first converts the input prompt into a vector representation prior to inputting the input prompt to the base AI model and the selected delta AI model—e.g., via a suitable vector embedding process. In other embodiments, the input prompt is already expressed as an input vector when it is received by the computing device—e.g., the input prompt may be vectorized by a client computing device from which the input prompt originates, vectorized by another computing device in a distributed AI inferencing platform of which computing device 100 is a component, or the input prompt may be initially generated as an input vector.

The inference request includes an indication 114 of a selected delta AI model of the set of two or more delta AI models implemented by the computing device. In some examples, the inference request additionally specifies the base AI model to which the input prompt should be input for inference—e.g., in cases where the computing device implements two or more different base AI models. Regardless, the inference request specifies any selected AI models in any suitable way, such as via one or more data fields and/or metadata fields included in the inference request that specify a unique identifier of an AI model implemented by the computing device.

The inference request is received by the computing device in any suitable way and from any suitable source. In some embodiments, the inference request is received over a computer network (e.g., local area network or wide area network) via a communications interface of the computing device. In the example of FIG. 1A, the inference request is received from another computing device of the distributed AI inferencing platform of which computing device 100 is a component, as will be described in more detail below. In other embodiments, however, the inference request has another suitable source. As additional non-limiting examples, the inference request may be generated by the computing device (e.g., output by a software application of the computing device) or retrieved from a storage device communicatively coupled with the computing device.

In the example of FIG. 1A, the input prompt 112 is input to the base AI model 106 to thereby generate a base model result vector 116. Similarly, the input prompt is input to the selected delta AI model to thereby generate a delta model result vector. In this example, the selected delta AI model is delta AI model 108A, which generates a delta model result vector 118. In other words, the same input prompt is separately provided both to the base AI model and the selected delta AI model, which perform inferencing to output different respective result vectors for the input prompt.

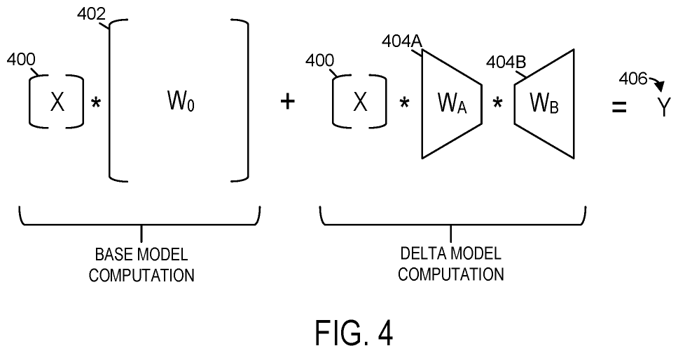

The computing device then generates an output vector by combining the base model result vector and the delta model result vector via a combination operation. In the example of FIG. 1A, base model result vector 116 and delta model result vector 118 are combined via a combination operation 120 to generate an output vector 122. The base model result vector and delta model result vector are combined in any suitable way, depending on the implementation. In some embodiments, the combination operation comprises summing the base model result vector and the delta model result vector. Result vector combination will be described in more detail below with respect to FIG. 4. It will be understood that the process illustrated in FIG. 1A is highly simplified for the sake of explanation—in practical scenarios, the base AI model and set of delta AI models may each comprise a plurality of layers (e.g., network layers) that perform different operations on the input data in generating the corresponding result vectors.

Upon generating the output vector via the combination operation, the computing device outputs the output vector 122. It will be understood that a vector may be “output” in various suitable ways depending on the implementation. In some embodiments, outputting the output vector includes passing the output vector to a downstream application (e.g., for decoding), transmitting the output vector to another computing device (e.g., to a client computing device, to another computing device of a distributed AI inferencing platform), writing the output vector to a data file, storing the output vector in non-volatile storage of the computing device, and/or storing the output vector in an external storage device communicatively coupled with the computing device.

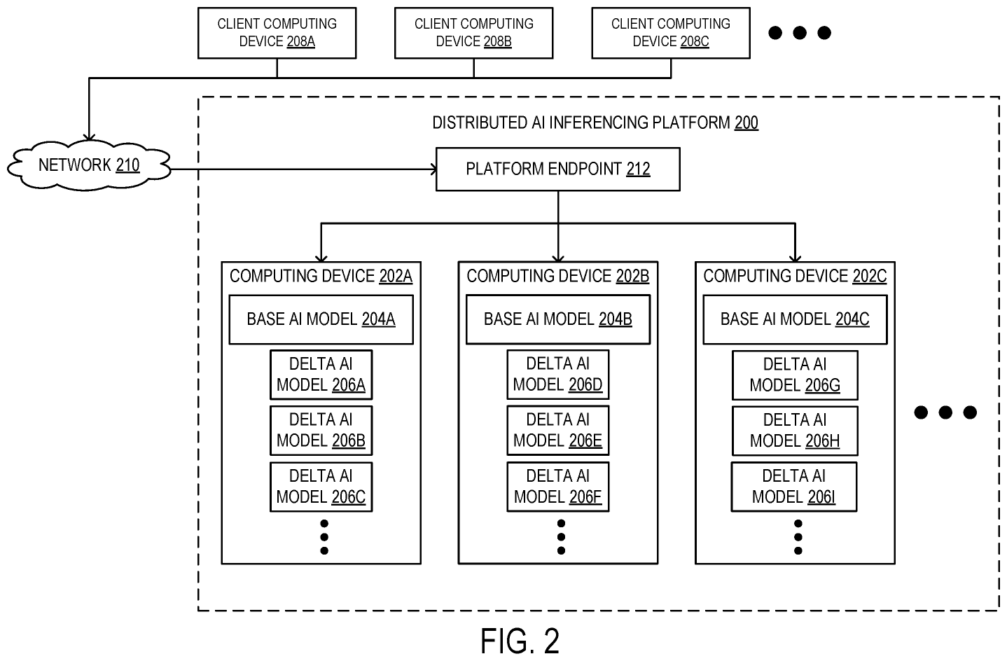

As discussed above, in some examples, the computing device is a component of a distributed AI inferencing platform. This is schematically shown in FIG. 1A, in which computing device 100 is a component of a distributed AI inferencing platform 124. The AI inferencing platform is implemented by a plurality of other computing devices in addition to computing device 100. In some examples, different computing devices of the distributed AI inferencing platform implement different base AI models and corresponding sets of delta AI models. This will be described in more detail below with respect to FIG. 2.

In the example of FIG. 1A, the distributed AI inferencing platform receives the input prompt from a client computing device 126. The client computing device may, for instance, be owned, operated, or otherwise associated with a user or customer of the distributed AI inferencing platform. The client computing device includes a memory 128 and a processor 130. As discussed above with respect to computing device 100, client computing device 126 has any suitable capabilities, hardware configuration, and form factor. In some embodiments, client computing device 126 is implemented as computing system 800 described below with respect to FIG. 8.

In the example of FIG. 1A, the client computing device generates a client request 132 that is transmitted to the distributed AI inferencing platform. As shown, the client request includes the input prompt 112 and an indication 134 of one or more selected AI models to which the input prompt should be input for inferencing. In some embodiments, the client request 132 and inference request 110 described above are the same—e.g., the client request transmitted by the client computing device is received substantially unchanged by computing device 100. In other embodiments, the client request 132 and inferencing request 110 include different types of data and/or are formatted, encoded, or otherwise expressed differently. For instance, in some embodiments, the distributed AI inferencing platform supports different base AI models implemented on different computing devices of the platform. As such, the client request 132 may specify a selected base AI model in addition to a selected delta AI model, such that the input prompt is delivered to the computing device of the AI inferencing platform that implements the selected base AI model.

Once generated by the client computing device, the client request 132 is, in the example of FIG. 1A, transmitted via a network 136 to the distributed AI inferencing platform. Network 136 may be implemented as any suitable computer network, including local-area networks, and/or wide-area networks such as the Internet. In this example, the client request is received by a platform endpoint 138 of the distributed AI inferencing platform.

Platform endpoint 138 includes a memory 140 and a processor 142. As discussed above with respect to computing device 100 and client computing device 126, the platform endpoint has any suitable capabilities, hardware configuration, and form factor. As one non-limiting example, the platform endpoint may be implemented as a server computing device. In some embodiments, platform endpoint 138 is implemented as computing system 800 described below with respect to FIG. 8.

In the example of FIG. 1A, the platform endpoint 138 implements a request routing module 144 that directs the client request 132 received from the client computing device 126 to the computing device 100. For instance, based on the indication 134 of the selected AI model specified in the client request, the platform endpoint may direct the request to computing device 100 based on a determination that computing device 100 implements the selected AI model. As such, in this example, computing device 100 receives the inference request 110 from platform endpoint 138. From there, the input prompt is input to the base AI model and selected delta AI model for inferencing as described above.

In the example of FIG. 1A, an inference request is input to the base AI model and the selected delta AI model for inferencing. However, as discussed above, the computing device implements a plurality of different delta AI models, representing a plurality of different adaptations of the bae AI model. As such, in some examples, the computing device receives additional inference requests including different input prompts and selected delta AI models, and the same computing device may fulfill two or more different inference requests concurrently.

FIG. 1B again schematically shows computing device 100. In this example, the computing device receives a second inference request 146 including a second input prompt 148 for inference. The second inference request includes an indication 150 specifying a second selected delta AI model of the two or more delta AI models. As with inference request 110 shown in FIG. 1A, second inference request 146 has any suitable source. As one example, the second inference request may be received over a computer network from another computing device, such as a client computing device (e.g., client computing device 126) or another computing device of a distributed AI inferencing platform (e.g., platform endpoint 138). In some examples, the second inference request originates from a different user or customer of the distributed AI inferencing platform.

In FIG. 1B, the second input prompt 148 is input to the base AI model to thereby generate a second base model result vector 152. Similarly, the second input prompt is input to the second selected delta AI model to thereby generate a second delta model result vector 154. In this example, the second selected delta AI model is delta AI model 108C implemented by computing device 100. Once the base model result vector and second delta model result vector are generated, the computing device generates a second output vector 158 by combining the second base model result vector and the second delta model result vector via a second combination operation 156. The second output vector is then output as described above with respect to the first output vector 122.

Notably, in this example, the inference request 110 and the second inference request 146 are received by the same computing device 100 of distributed AI inferencing platform 124, and the two inference requests are fulfilled at least partially concurrently by the same computing device. In other words, the delta model result vector 118 and the second delta model result vector 154 are concurrently generated by the same computing device 100. This beneficially improves the inferencing throughput of the computing device.

FIG. 2 schematically depicts another example distributed AI inferencing platform 200 that is provided by a plurality of different computing devices, including at least a computing device 202A, computing device 202B, and computing device 202C. In this example, a plurality of different base AI models and delta AI models are implemented by the plurality of computing devices of the distributed AI inferencing platform. Specifically, computing device 202A implements a base model 204A and a set of delta AI models 206A-C for base AI model 204A. Similarly, computing device 202B implements a base AI model 204B and a set of delta AI models 206D-F for base AI model 204B, and computing device 204C implements a base AI model 204C and a set of delta AI models 206G-I for base AI model 204C.

It will be understood that a distributed AI inferencing platform may be cooperatively provided by any suitable number of computing devices. Any computing device used to provide a distributed AI inferencing platform may implement any suitable number of AI models, including base AI models and delta AI models. As discussed above with respect to computing device 100, the present disclosure primarily focuses on scenarios where each computing device implements one base AI model and an associated set of two or more delta AI models, although this is non-limiting.

In some embodiments, various computing devices used to collectively provide a distributed AI inferencing model each implement different base AI models and associated sets of delta AI models. For instance, in FIG. 2, base AI model 204A is a different model (e.g., having a different set of trained parameters) from base AI model 204B, and is different from base AI model 204C. However, in other embodiments, two or more different computing devices may each implement different copies of the same base AI model. In such cases, the devices may implement the same or different sets of delta AI models for the base AI model.

For instance, in some embodiments, two or more different computing devices implement the same base AI model and the same sets of delta AI models. This enables scaling of the inference throughput for the base AI model on a platform level. If it is determined that a particular base AI model is heavily utilized by users or customers of the distributed AI inferencing platform, additional computing devices of the platform can be provisioned with the same base AI model and set of delta AI models to facilitate a higher inferencing throughput. In some embodiments, two or more different computing devices implement the same base AI model and different sets (e.g., exclusive sets or overlapping sets) of delta AI models.

In the example of FIG. 2, the distributed AI inferencing platform provides inferencing services to a plurality of client computing devices, including devices 208A, 208B, and 208C. These may, for instance, correspond to different customers, users, clients, or other parties receiving inferencing services from the distributed AI inferencing platform. In some embodiments, different delta AI models of the distributed AI inferencing platform are associated with different parties—e.g., representing an adaptation of an existing base AI model toward that party's particular preferences, workflow, or context.

The client computing devices communicate with the distributed AI inferencing platform via a network 210, which communicatively couples the client computing devices with a platform endpoint 212 of the distributed AI inferencing platform. The platform endpoint may, for instance, route client inference requests from different client computing devices to computing devices within the platform that implement AI models specified by the client inference requests. It will be understood that the distributed AI inferencing platform may include any suitable number and variety of different computing devices, which perform any suitable number of functions in addition to, or instead of, implementing AI models. For instance, computing devices within the distributed AI inferencing platform may provide routing functions, inference throughput monitoring, load balancing, telemetry collection, etc.

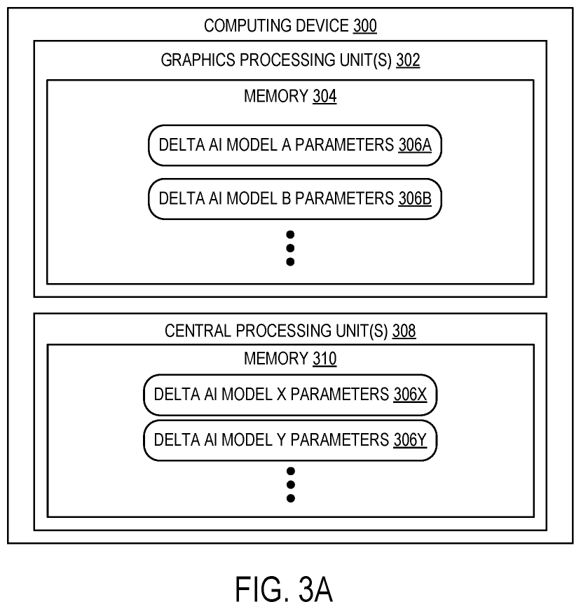

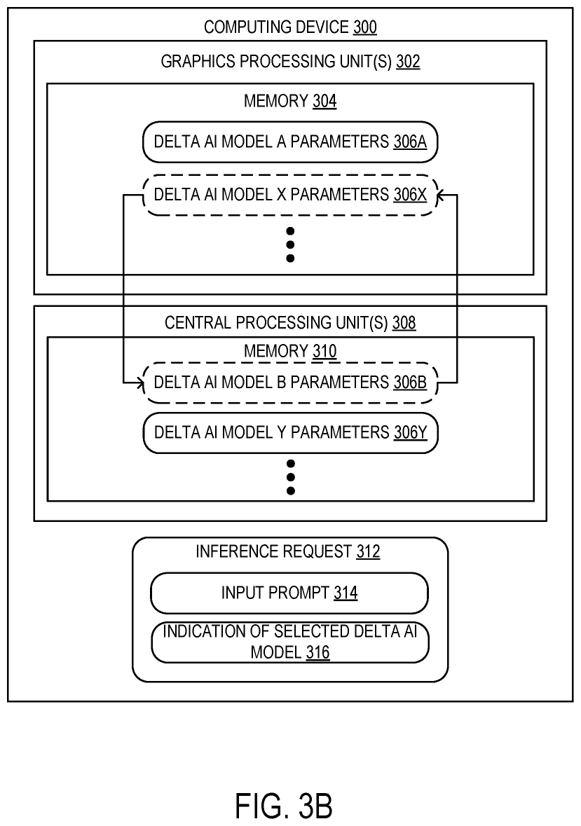

As discussed above, a base AI model or delta AI model is “implemented” by a computing device when one or more parameters of the AI model are loaded into memory of the computing device, such that the AI model can be executed by the processor of the computing device. In some embodiments, base AI models and delta AI models are implemented by loading parameters for the models into memory of one or more GPUs of the computing device. This is schematically illustrated with respect to FIGS. 3A and 3B, depicting another example computing device 300. As shown, computing device 300 includes one or more GPUs 302, which collectively include GPU memory 304. Parameters 306A and 306B for different delta AI models are stored in the GPU memory, where they may be used by the GPU to perform inferencing on input prompts. For instance, upon receiving an inference request specifying a delta AI model having parameters stored in the GPU memory, the input prompt may be input to the selected delta AI model to generate a delta model result vector.

Additionally, computing device 300 includes a CPU 308 having its own associated CPU memory 310. In this example, parameters 308X and 308Y for additional delta AI models are stored in the CPU memory. In this manner, CPU memory can be used as a form of extra storage for delta AI models. For instance, in some embodiments, delta AI models stored in CPU memory are not used for inferencing in response to input prompts. However, should an inference request be received that specifies a delta AI model stored in CPU memory, parameters for the specified model can be loaded into GPU memory to be used for inference relatively quickly—e.g., more quickly than loading the parameters from non-volatile storage. This can enable an owner or operator of the computing device to “oversubscribe” the number of models stored on the computing device—e.g., the computing device stores more AI models that can be implemented at any one time. For instance, delta AI models that are used relatively frequently can be stored in GPU memory, while delta AI models that are used relatively less frequently can be stored in CPU memory and loaded into GPU memory as needed.

FIG. 3B again schematically depicts computing device 300. In this example, the computing device has received an inference request 312 that includes an input prompt 314 and an indication 316 of a selected delta AI model. The selected delta AI model is delta AI model 308X, and model parameters of the selected delta AI model are stored in the memory of the CPU of the computing device in the scenario depicted in FIG. 3A. In FIG. 3B, upon receiving the inference request specifying the selected delta AI model, the computing device loads the model parameters for the selected delta AI model into the memory of the one or more GPUs of the computing device.

Additional detail with respect to use of a base AI model and delta AI to generate an output vector will now be described with respect to FIG. 4. In FIG. 4, input [X] 400 is used to denote an input vector of values that are multiplied with a matrix of weights [W₀] 402 of a base AI model. For instance, the input vector 400 may be a vector representation of an input prompt described above, while the weights 402 represent the entire set of weight values of the base AI model. In a more specific example, the weights 402 represent one or more weight matrices of a single transformer block of a transformer model, while the input vector 400 is the input to the transformer block.

In FIG. 4, the input vector 400 is separately multiplied with a first delta matrix [WA] 404A and a second delta matrix [WB] 404B. As one non-limiting example, the first and second delta matrices are implemented as part of a LoRA model. Using two different matrices in this manner can be used to reduce the dimensionality of the model parameters. It has been shown that weight matrices of a delta model can have a rank that is lower than the dimensionality of the base AI model, which enables delta AI models to be smaller and faster to train than the base AI model. As such, matrices of a delta AI model can be described as “rank decomposition matrices” that reduce the effective rank of the weight matrix of the base AI model. In other words, in some embodiments, the selected delta AI model specified in an inference request includes one or more trained rank decomposition matrices corresponding to a weight matrix of the base AI model.

In one example implementation, using d to refer to the dimensionality of the base AI model, and r to refer to the rank of the delta AI model, the first delta matrix 404A has a dimensionality of d×r and the second delta matrix 404B has a dimensionality of r×2d. This enables the input vector to the first delta matrix to have the same dimensionality as is provided to the base AI model, and enables the output result of the second delta matrix to have the same dimensionality as the output result from the base AI model. In this manner, the base model result vector and delta model result vector can be summed (or combined in another suitable way) to give an output vector 406, denoted as Y in FIG. 4.

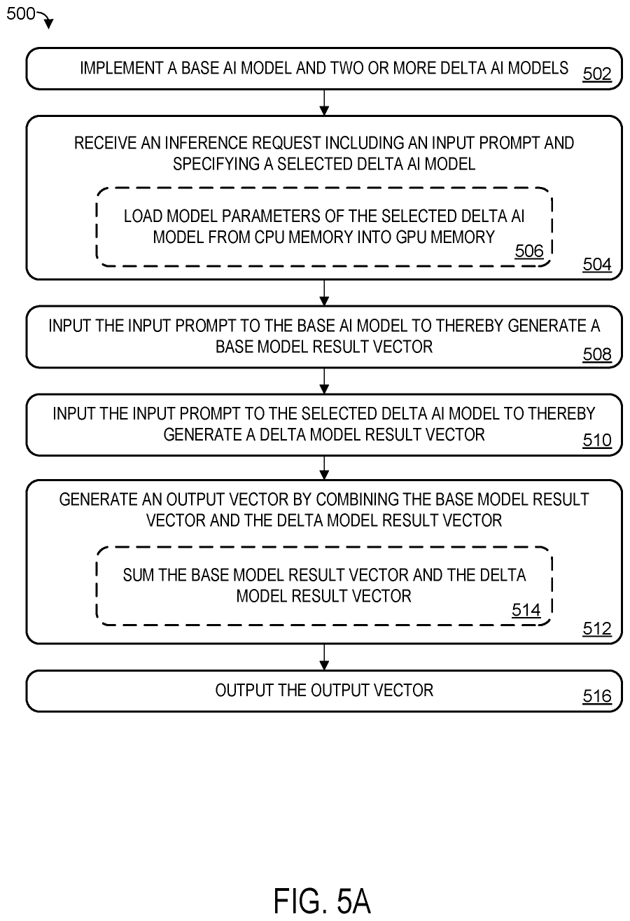

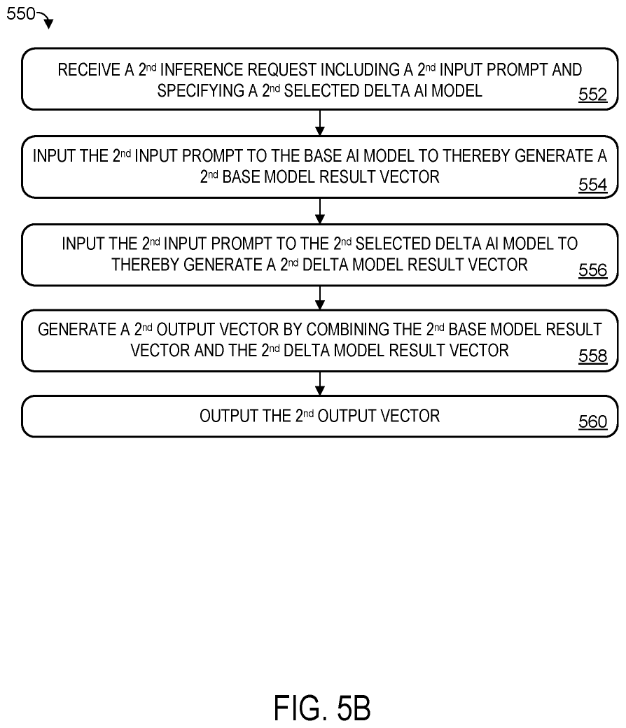

FIG. 5A illustrates an example method 500 for AI inferencing. Steps of method 500, as well as methods 550 and 600 described below, may be implemented by any suitable computing device having any suitable capabilities, hardware configuration, and form factor. As non-limiting examples, methods 500, 550, and/or 600 may be implemented by any of the computing devices 100, 202A-C, or 300 described above, or computing system 800 described below with respect to FIG. 8. Steps of methods 500, 550, and/or 600 may be initiated, terminated, repeated, and/or looped at any suitable time and in response to any suitable condition.

At 502, method 500 includes implementing a base AI model and two or more delta AI models. At 504, method 500 includes receiving an inference request including an input prompt and specifying a selected delta AI model. In some examples, this optionally includes, at 506, loading model parameters of the selected delta AI model from CPU memory into GPU memory. At 508, method 500 includes inputting the input prompt to the base AI model to thereby generate a base model result vector. At 510, method 500 includes inputting the input prompt to the selected delta AI model to thereby generate a delta model result vector. At 512, method 500 includes generating an output vector by combining the base model result vector and the delta model result vector. In some examples, at 514, the combination operation includes summing the base model result vector and the delta model result vector. At 516, method 500 includes outputting the output vector.

FIG. 5B illustrates another example method 550. In some embodiments, one or more steps of method 550 occur concurrently with one or more steps of method 500. At 552, method 550 includes receiving a second inference request including a second input prompt and specifying a second selected delta AI model. At 554, method 550 includes inputting the second input prompt to the base AI model to thereby generate a second base model result vector. At 556, method 550 includes inputting the second input prompt to the second selected delta AI model to thereby generate a second delta model result vector. As discussed above, in some examples, the delta model result vector for an input prompt is generated at least partially concurrently with a second delta mode for a second input prompt by the same computing device. At 558, method 550 includes generating a second output vector by combining the second base model result vector and the second delta model result vector. At 560, method 550 includes outputting the second output vector.

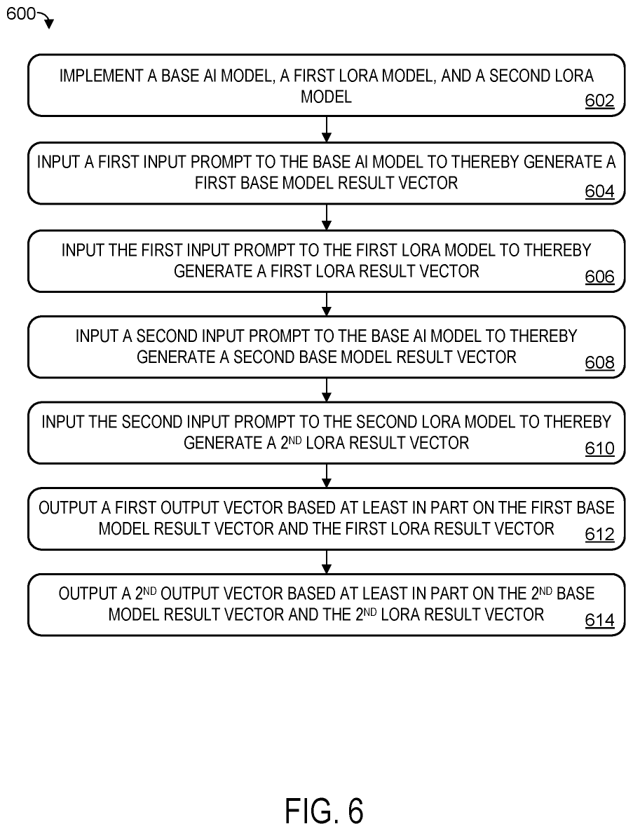

FIG. 6 illustrates another example method 600 for AI inferencing. In the example of FIG. 6, the delta AI models are implemented as LoRA models. At 602, method 600 includes implementing a base AI model, a first LoRA model, and a second LoRA model. At 604, method 600 includes inputting a first input prompt to the base AI model to thereby generate a first base model result vector. At 606, method 600 includes inputting the first input prompt to the first LoRA model to thereby generate a first LoRA result vector. At 608, method 600 includes inputting a second input prompt to the base AI model to thereby generate a second base model result vector. At 610, method 600 includes inputting the second input prompt to the second LoRA model to thereby generate a second LoRA result vector. In some cases, the first LoRA result vector is generated at least partially concurrently with the second LoRA result vector by the same computing device. At 612, method 600 includes outputting a first output vector based at least in part on the first base model result vector and the first LoRA result vector. At 614, method 600 includes outputting a second output vector based at least in part on the second base model result vector and the second LoRA result vector.

As discussed above, the techniques described herein are in some examples applied as part of a distributed AI inferencing platform, in which a plurality of different computing devices collectively implement a plurality of different base AI models and delta AI models. The distributed AI inferencing platform may receive inference requests from outside parties (e.g., customers, clients, users) that include input prompts, and specify different base AI models and delta AI models into which the input prompts should be input for inferencing. Due to the potentially large number of different computing devices used to collectively provide the inferencing platform, and the potentially large number of different delta AI models hosted on each computing device, it can be challenging to route inference requests to a computing device capable of fulfilling it—e.g., a computing device that is currently implementing instances of the selected base and delta AI models, and currently capable of performing inferencing using such models. This is exacerbated by the fact that the AI models implemented by any particular computing device are sometimes taken offline for updates, migrated to other computing devices, or otherwise made unavailable for various reasons.

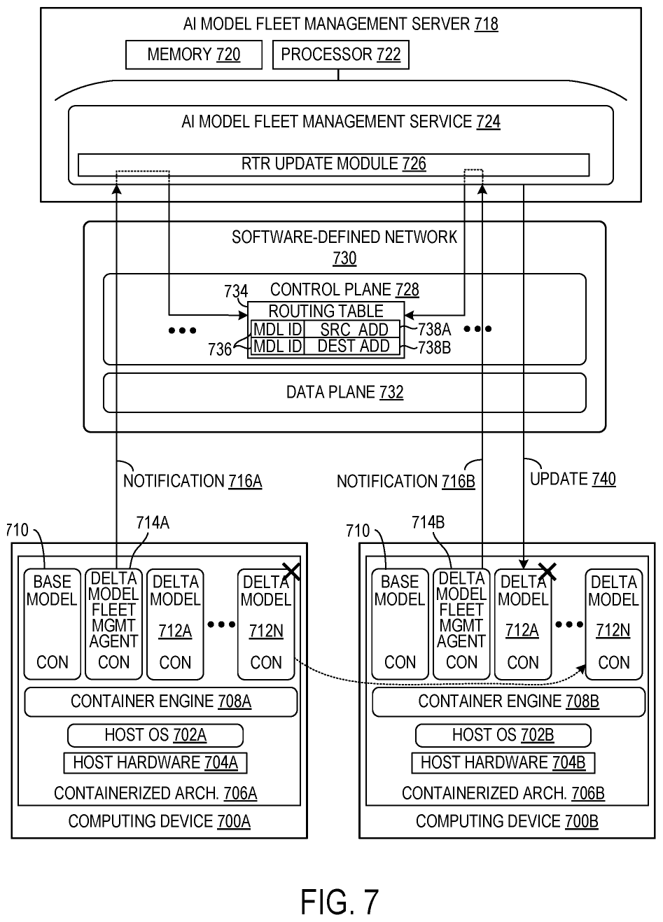

Accordingly, FIG. 7 schematically illustrates use of an AI model fleet management service to track the allocation of, and update network routing information pertaining to, AI models implemented as part of a distributed AI inferencing platform. Specifically, FIG. 7 schematically shows computing devices 700A and 700B under the management of a delta AI model fleet management server 718. Computing device 700A includes a host operating system (OS) 702A executed by host hardware 704A, which is used to implement a containerized architecture 706A and a container engine 708A. Container engine 708A provides a software interface between host OS 702A and a set of containers. Each container includes respective application programs, libraries, binaries, and other data used by the applications hosted within the containers. Similarly, computing device 700B uses a host OS 702B and host hardware 704B to implement a containerized architecture 706B and container engine 708B, which provide an interface between host OS 702B and another set of containers. Though the example of FIG. 7 uses a containerized architecture, it will be understood that in other examples, virtual machines may be used in addition to or instead of containers.

In FIG. 7, different containers of computing devices 700A and 700B are used to implement a plurality of different AI models, including base AI models and delta AI models as discussed above. As shown, both computing device 700A and computing device 700B implement separate containerized instances of a base AI model 710. Additionally, the computing devices each implement different containerized instances of delta AI models 712A-712N. Use of containers in this manner beneficially facilitates portability of the AI models, for instance by enabling relatively quick and simple migration or duplication of an AI model from one computing device to another.

As discussed above, the AI models implemented by any given computing device may be taken offline for various reasons—e.g., for updates or migration to another computing device. In the example of FIG. 7, delta AI model 712N is migrated from computing device 700A to computing device 700B. Thus, delta AI model 712N is no longer available on computing device 700A, and newly available on computing device 700B. Various factors may prompt the migration of an AI model from a source computing device to a destination computing device. Such factors may include insufficient compute resources at the source computing device to support inference requests targeting the AI model, and/or degradation in the functioning of the source computing device.

As such, computing device 700A includes a delta model fleet management agent 714A. Similarly, computing device 700B includes a delta model fleet management agent 714B. In the example of FIG. 7, the fleet management agents are themselves implemented in containers hosted by the computing devices. Each delta model fleet management agent tracks the AI models currently implemented on its corresponding computing device, and tracks the status of each AI model—e.g., whether the AI model is available for inferencing, offline for an update, migrated to another computing device, or offline for another suitable reason.

The delta model fleet management agents provide model availability status notifications 716A and 716B, specifying changes to the status of the AI models implemented by computing devices 700A and 700B, to a delta AI model fleet management server 718. Such notifications may include any suitable information pertaining to the current availability status of an AI model—e.g., that the model is online, offline, being updated, being migrated, being brought online, and/or in use. In this example, delta AI model 712N has been migrated from computing device 700A to 700B. This is specified by notifications 716A and 716B—e.g., notification 716A is a notification to the fleet management server that delta AI model 712N is no longer available on computing device 700A, and notification 716B is a notification to the fleet management server that delta AI model 712N is now available on computing device 700B.

AI model fleet management server 716 includes a memory 720 and processor 722, which are used to implement an AI model fleet management service 724. The AI model fleet management service performs any suitable functions relating to tracking and/or managing the availability of AI models across the AI inferencing platform. For instance, in some examples, the migration of delta AI model 712N from computing device 700A to computing device 700B is prompted by the fleet management service. This may be done, for instance, based on a determination by the fleet management service that the available inferencing bandwidth of computing device 700A is insufficient to handle the volume of inference requests targeting delta AI model 712N, and thus the inferencing throughput of the platform could be improved by moving the delta AI model to a less-utilized computing device. In general, the fleet management service may communicate with the AI model fleet management agents to control allocation of AI models to different computing devices, update the AI models, migrate containers hosting different AI models from one computing device to another, and/or perform other suitable functions.

In FIG. 7, AI model fleet management service 724 includes a router update module 726 used to update a network router that includes network address information for different AI models in the platform. As shown, based on notifications 716A and 716B, the router update module 726 transmits information relating to the container migration to a control plane 728 of a software-defined network (SDN) 730. SDN 730 is configured to route network traffic through a data plane 732, based on network routing information, policies, rules, and/or other configuration information set at the control plane 728 of the SDN. The SDN may be used to implement network routes along which network traffic is routed, network topologies in which to organize networking in the computing system, enforce policies and rules, and perform other functions related to networking in the computing system. Network routes and topologies may be established at, in least in part, a logical level, with various physical networking devices (e.g., routers, switches) implementing such routes and topologies.

To this end, SDN 730 maintains a network routing table 734 tracking unique identifiers 736 for AI models implemented by the distributed AI inferencing platform, and network address information pertaining to the AI models. In this example, the routing table has been updated to include the source network address 738A corresponding to delta AI model 712N, and a destination network address 738B at which the delta AI model is accessible after migration. It will be understood that a network address takes any suitable form and refers to any suitable entity—e.g., the source and destination addresses may be internet protocol (IP) addresses for computing devices 700A and 700B, routers associated with the computing devices, virtualized resources (e.g., containers) implemented by the computing devices, etc. When inference requests are received, the delta AI model fleet management service (and/or other services within the platform) may consult the network routing table to determine the computing device to which the inference requests should be routed. In this manner, inference requests specifying delta AI model 712N can be routed to computing device 700B for inferencing, rather than computing device 700A.

It will be understood that migration of a delta AI model from one computing device to another is not the only scenario in which the availability of an AI model on a computing device may change. As another example, an AI model may become temporarily unavailable while the AI model is updated. This is also schematically illustrated with respect to FIG. 7, in which the instance of delta AI model 712A on computing device 700B is undergoing an update. As shown, AI model fleet management service 724 transmits an update 740 to delta AI model 712A to computing device 700B. In some examples, the update transmitted by the fleet management service includes the updated model parameters for the AI model—e.g., the AI model fleet management service transmits an updated instance of the model to the computing device. In other cases, the update transmitted by the fleet management service does not directly update the containerized AI model instance, but rather includes instructions for updating the AI model—e.g., the update may specify a network location at which updated parameters are stored, timing information with which the model should be updated, and/or other suitable update instructions.

In any case, while the delta AI model is being updated, it is unavailable for handling inference requests. As such, in some examples, the notification 716B transmitted by computing device 700B additionally specifies that its instance of delta AI model 712A is currently offline due to the update. Alternatively, computing device 700B may transmit separate notifications pertaining to the migration of delta AI model 712N and the update of delta AI model 712A. In response, the router update module may update the network routing table 734 to specify that requests targeting delta AI model 712A should be routed to computing device 700A and not computing device 700B. In some examples, once the update to the delta AI model is finished and the model is again available to handle inference requests, computing device 700B transmits a subsequent notification to the fleet management service indicating that the model is once again available. The router update module may then again update the network router to indicate that instances of delta AI model 712A are available at either of the computing devices 700A or 700B.

In this manner, upon detecting a change in availability status of an AI model implemented by a computing device, where the computing device implements a base AI model and two or more delta AI models, an AI model fleet management agent of the computing device transmits an availability status notification to an AI model fleet management service. The AI model fleet management service causes a network routing table to be updated at a control plane of a software-defined network (SDN), where the network routing table includes unique identifiers corresponding to different AI models, and network addresses at which the AI models are accessible. For instance, in examples where the change in availability status includes a migration of an AI model from one computing device to another (e.g., via migration of a container hosting a delta AI model), the network routing table may be updated with a destination network address to which inference requests specifying the migrated AI model should be routed.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 8 schematically shows a non-limiting embodiment of a computing system 800 that can enact one or more of the methods and processes described above. Computing system 800 is shown in simplified form. Computing system 800 may embody the computing system 1 described above and illustrated in FIG. 1. Components of computing system 800 may be included in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 800 includes a logic processor 802 volatile memory 804, and a non-volatile storage device 806. Computing system 800 may optionally include a display subsystem 808, input subsystem 810, communication subsystem 812, and/or other components not shown in FIG. 8.

Logic processor 802 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 802 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 806 includes one or more physical devices configured to hold instructions executable by the logic processors to implement the methods and processes described herein. When such methods and processes are implemented, the state of non-volatile storage device 806 may be transformed—e.g., to hold different data.

Non-volatile storage device 806 may include physical devices that are removable and/or built in. Non-volatile storage device 806 may include optical memory, semiconductor memory, and/or magnetic memory, or other mass storage device technology. Non-volatile storage device 806 may include nonvolatile, dynamic, static, read/write, read-only, sequential-access, location-addressable, file-addressable, and/or content-addressable devices. It will be appreciated that non-volatile storage device 806 is configured to hold instructions even when power is cut to the non-volatile storage device 806.

Volatile memory 804 may include physical devices that include random access memory. Volatile memory 804 is typically utilized by logic processor 802 to temporarily store information during processing of software instructions. It will be appreciated that volatile memory 804 typically does not continue to store instructions when power is cut to the volatile memory 804.

Aspects of logic processor 802, volatile memory 804, and non-volatile storage device 806 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 800 typically implemented in software by a processor to perform a particular function using portions of volatile memory, which function involves transformative processing that specially configures the processor to perform the function. Thus, a module, program, or engine may be instantiated via logic processor 802 executing instructions held by non-volatile storage device 806, using portions of volatile memory 804. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 808 may be used to present a visual representation of data held by non-volatile storage device 806. The visual representation may take the form of a graphical user interface (GUI). As the herein described methods and processes change the data held by the non-volatile storage device, and thus transform the state of the non-volatile storage device, the state of display subsystem 808 may likewise be transformed to visually represent changes in the underlying data. Display subsystem 808 may include one or more display devices utilizing virtually any type of technology. Such display devices may be combined with logic processor 802, volatile memory 804, and/or non-volatile storage device 806 in a shared enclosure, or such display devices may be peripheral display devices.

When included, input subsystem 810 may comprise or interface with one or more user-input devices such as a keyboard, mouse, touch screen, camera, or microphone.

When included, communication subsystem 812 may be configured to communicatively couple various computing devices described herein with each other, and with other devices. Communication subsystem 812 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 800 to send and/or receive messages to and/or from other devices via a network such as the Internet.

In an example, a computing device comprises: a processor; and a storage device holding instructions executable by the processor to: implement a base artificial intelligence (AI) model and two or more delta AI models, each delta AI model having lower dimensionality than the base AI model; receive an inference request including an input prompt, the inference request specifying a selected delta AI model of the two or more delta AI models; input the input prompt to the base AI model to thereby generate a base model result vector; input the input prompt to the selected delta AI model to thereby generate a delta model result vector; generate an output vector by combining the base model result vector and the delta model result vector via a combination operation; and output the output vector. In this example or any other example, the instructions are further executable to: receive a second inference request including a second input prompt for inference and specifying a second selected delta AI model of the two or more delta AI models; input the second input prompt to the base AI model to thereby generate a second base model result vector; input the second input prompt to the second selected delta AI model to thereby generate a second delta model result vector; generate a second output vector by combining the second base model result vector and the second delta model result vector via a second combination operation; and output the second output vector. In this example or any other example, the computing device is a component of a distributed AI inferencing platform in which a plurality of different base AI models and delta AI models are implemented by a plurality of computing devices, and wherein the delta model result vector and the second delta model result vector are concurrently generated by a same computing device of the plurality of computing devices. In this example or any other example, the selected delta AI model includes one or more trained rank decomposition matrices corresponding to a weight matrix of the base AI model. In this example or any other example, the combination operation comprises summing the base model result vector and the delta model result vector. In this example or any other example, model parameters of the selected delta AI model are stored in memory of one or more graphics processing units (GPUs) of the computing device. In this example or any other example, model parameters for a second delta AI model of the two or more delta AI models are stored in memory of a central processing unit (CPU) of the computing device. In this example or any other example, the instructions are further executable to, upon receiving a second inference request specifying the second delta AI model, load the model parameters for the second delta AI model into the memory of the one or more GPUs of the computing device. In this example or any other example, the base AI model is a transformer model. In this example or any other example, the two or more delta AI models are selected from a group consisting of Low-Rank Adaptation (LoRA) models, BitFit models, Adapter models, and Compactor models. In this example or any other example, a quantity of the two or more delta AI models implemented by the computing device is selected based on one or both of a service level agreement (SLA) and a cost of goods sold (COGS) calculation.

In an example, a method for artificial intelligence (AI) model inferencing comprises: implementing a base AI model and two or more delta AI models, each delta AI model having lower dimensionality than the base AI model; receiving an inference request including an input prompt, the inference request specifying a selected delta AI model of the two or more delta AI models; inputting the input prompt to the base AI model to thereby generate a base model result vector; inputting the input prompt to the selected delta AI model to thereby generate a delta model result vector; generating an output vector by combining the base model result vector and the delta model result vector via a combination operation; and outputting the output vector. In this example or any other example, the method further comprises: receiving a second inference request including a second input prompt for inference and specifying a second selected delta AI model of the two or more delta AI models; inputting the second input prompt to the base AI model to thereby generate a second base model result vector; inputting the second input prompt to the second selected delta AI model to thereby generate a second delta model result vector; generating a second output vector by combining the second base model result vector and the second delta model result vector via a second combination operation; and outputting the second output vector. In this example or any other example, the inference request and the second inference request are received by a same computing device of a distributed AI inferencing platform in which a plurality of different base AI models and delta AI models are implemented by a plurality of different computing devices, and wherein the delta model result vector and the second delta model result vector are concurrently generated by the same computing device. In this example or any other example, the selected delta AI model includes one or more trained rank decomposition matrices corresponding to a weight matrix of the base AI model. In this example or any other example, model parameters of the selected delta AI model are stored in memory of one or more graphics processing units (GPUs) of a computing device. In this example or any other example, model parameters for a second delta AI model of the two or more delta AI models are stored in memory of a central processing unit (CPU) of the computing device. In this example or any other example, the method further comprises, upon receiving a second inference request specifying the second delta AI model, loading the model parameters for the second delta AI model into the memory of the one or more GPUs of the computing device. In this example or any other example, the base AI model is a transformer model.

In an example, a method for artificial intelligence (AI) inferencing comprises: implementing a base AI model, a first Low-Rank Adaptation (LoRA) model, and a second LoRA model on a same computing device of a plurality of different computing devices collectively providing a distributed AI inferencing platform; inputting a first input prompt to the base AI model to thereby generate a first base model result vector; inputting the first input prompt to the first LoRA model to thereby generate a first LoRA result vector; inputting a second input prompt to the base AI model to thereby generate a second base model result vector; inputting the second input prompt to the second LoRA model to thereby generate a second LoRA result vector, wherein the first LoRA result vector and the second LoRA result vector are generated concurrently by the same computing device of the plurality of different computing devices; outputting a first output vector based at least in part on the first base model result vector and the first LoRA result vector; and outputting a second output vector based at least in part on the second base model result vector and the second LoRA result vector.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device, comprising:
a processor; and
a storage device holding instructions executable by the processor to:
implement a base artificial intelligence (AI) model and two or more delta AI models, each delta AI model having lower dimensionality than the base AI model;
receive an inference request including an input prompt, the inference request specifying a selected delta AI model of the two or more delta AI models;
input the input prompt to the base AI model to thereby generate a base model result vector;
input the input prompt to the selected delta AI model to thereby generate a delta model result vector;
generate an output vector by combining the base model result vector and the delta model result vector via a combination operation; and
output the output vector.

2. The computing device of claim 1, wherein the instructions are further executable to:
receive a second inference request including a second input prompt for inference and specifying a second selected delta AI model of the two or more delta AI models;
input the second input prompt to the base AI model to thereby generate a second base model result vector;
input the second input prompt to the second selected delta AI model to thereby generate a second delta model result vector;
generate a second output vector by combining the second base model result vector and the second delta model result vector via a second combination operation; and
output the second output vector.

3. The computing device of claim 2, wherein the computing device is a component of a distributed AI inferencing platform in which a plurality of different base AI models and delta AI models are implemented by a plurality of computing devices, and wherein the delta model result vector and the second delta model result vector are concurrently generated by a same computing device of the plurality of computing devices.

4. The computing device of claim 1, wherein the selected delta AI model includes one or more trained rank decomposition matrices corresponding to a weight matrix of the base AI model.

5. The computing device of claim 1, wherein the combination operation comprises summing the base model result vector and the delta model result vector.

6. The computing device of claim 1, wherein model parameters of the selected delta AI model are stored in memory of one or more graphics processing units (GPUs) of the computing device.

7. The computing device of claim 6, wherein model parameters for a second delta AI model of the two or more delta AI models are stored in memory of a central processing unit (CPU) of the computing device.

8. The computing device of claim 7, wherein the instructions are further executable to, upon receiving a second inference request specifying the second delta AI model, load the model parameters for the second delta AI model into the memory of the one or more GPUs of the computing device.

9. The computing device of claim 1, wherein the base AI model is a transformer model.

10. The computing device of claim 1, wherein the two or more delta AI models are selected from a group consisting of Low-Rank Adaptation (LoRA) models, BitFit models, Adapter models, and Compactor models.

11. The computing device of claim 1, wherein a quantity of the two or more delta AI models implemented by the computing device is selected based on one or both of a service level agreement (SLA) and a cost of goods sold (COGS) calculation.

12. A method for artificial intelligence (AI) model inferencing, the method comprising:
implementing a base AI model and two or more delta AI models, each delta AI model having lower dimensionality than the base AI model;
receiving an inference request including an input prompt, the inference request specifying a selected delta AI model of the two or more delta AI models;
inputting the input prompt to the base AI model to thereby generate a base model result vector;
inputting the input prompt to the selected delta AI model to thereby generate a delta model result vector;
generating an output vector by combining the base model result vector and the delta model result vector via a combination operation; and
outputting the output vector.

13. The method of claim 12, further comprising:
receiving a second inference request including a second input prompt for inference and specifying a second selected delta AI model of the two or more delta AI models;
inputting the second input prompt to the base AI model to thereby generate a second base model result vector;
inputting the second input prompt to the second selected delta AI model to thereby generate a second delta model result vector;
generating a second output vector by combining the second base model result vector and the second delta model result vector via a second combination operation; and
outputting the second output vector.

14. The method of claim 13, wherein the inference request and the second inference request are received by a same computing device of a distributed AI inferencing platform in which a plurality of different base AI models and delta AI models are implemented by a plurality of different computing devices, and wherein the delta model result vector and the second delta model result vector are concurrently generated by the same computing device.

15. The method of claim 12, wherein the selected delta AI model includes one or more trained rank decomposition matrices corresponding to a weight matrix of the base AI model.

16. The method of claim 12, wherein model parameters of the selected delta AI model are stored in memory of one or more graphics processing units (GPUs) of a computing device.

17. The method of claim 16, wherein model parameters for a second delta AI model of the two or more delta AI models are stored in memory of a central processing unit (CPU) of the computing device.

18. The method of claim 17, further comprising, upon receiving a second inference request specifying the second delta AI model, loading the model parameters for the second delta AI model into the memory of the one or more GPUs of the computing device.

19. The method of claim 12, wherein the base AI model is a transformer model.

20. A method for artificial intelligence (AI) inferencing, the method comprising:
implementing a base AI model, a first Low-Rank Adaptation (LoRA) model, and a second LoRA model on a same computing device of a plurality of different computing devices collectively providing a distributed AI inferencing platform;
inputting a first input prompt to the base AI model to thereby generate a first base model result vector;
inputting the first input prompt to the first LoRA model to thereby generate a first LoRA result vector;
inputting a second input prompt to the base AI model to thereby generate a second base model result vector;
inputting the second input prompt to the second LoRA model to thereby generate a second LoRA result vector, wherein the first LoRA result vector and the second LoRA result vector are generated concurrently by the same computing device of the plurality of different computing devices;
outputting a first output vector based at least in part on the first base model result vector and the first LoRA result vector; and
outputting a second output vector based at least in part on the second base model result vector and the second LoRA result vector.
